(19) United States
(12) Patent Application Publication
(10) Pub. No.: US 2009/0216503 A1
(43) Pub. Date: Aug. 27, 2009

(54) Method and system for converting a traditional architecual plan for a structure into a panelized system plan for the structure

(76) Inventor: Johanna Maxine Ossmann, St. Petersburg, FL (US)

Correspondence Address: Hanify & King Professional Corporation, 1055 Thomas Jefferson Street, NW, Suite 400, WASHINGTON, DC, 20007, US

(21) Appl. No.: 12/285,443

(22) Filed: Oct. 6, 2008

Related U.S. Application Data
(63) Continuation-in-part of application No. 11/350,741, filed on Feb. 10, 2006.
Application No. 11/350,741 is a continuation-in-part of application No. 11/201,156, filed on Aug. 11, 2005.

(51) Int. Cl. G06F 17/50

(52) U.S. Cl. 703/1

(57) ABSTRACT

An (note: an electronic version is not always received. Many times it's traditional hard copy and must be converted to electronic format) traditional architectural plan along with any structural drawings for a structure is received as input. Selected walls of the structure depicted in the architectural plan, such as external walls, are replaced with representations of building panels. Some of the building panel representations (standard building panels) have substantially the same dimensions (i.e., height, width and length), but may be configured with different structural elements including, but not limited to, peripheral frame, window openings, door openings, and electrical components. Some of the building panel representations have dimensions that are customized (customized building panels) and different from the dimensions of a standard panel representation. Customized building panel representations can also include structural elements, including but not limited to, window openings, door openings, and electrical components.

### CROSS REFERENCE TO RELATED APPLICATIONS

The present application claims priority to U.S. application Ser. No. 11/350,741, filed Feb. 10, 2006, now pending, which claims priority to U.S. application Ser. No. 11/201,156, filed Aug. 11, 2005, now pending.

### BACKGROUND OF THE INVENTION

1. Field of the Invention

The present invention relates to a method and system for designing a structure using a building panel system. More particularly, the present invention relates to a method and system for converting a traditional architectural plan for a structure into a building panel system plan for the structure so that the structure can be constructed using a system of building panels.

2. Description of the Prior Art

The construction industry is continuously attempting to find ways to reduce the time, cost, and labor associated with the construction of a structure including portions of a structure such as a exterior walls, and interior rooms. Techniques used to reduce the time, cost, and labor associated with the construction of a structure includes prefabrication of various portions of the structure. Typically, once a portion of a structure is fabricated, it is then transported to the construction site for use in the construction of the structure. One problem with using prefabricated building panels to construct a structure is that the architectural plan for the structure and associated structural working drawings that include structural elements such as the location of studs, support beams, electrical wiring, plumbing, doors, windows, and the like, are not drafted to provide any guidance or instruction on how to substitute portions of the structure with prefabricated building panels.

Accordingly, there is a need for a method and system for converting a traditional two dimensional architectural plan for a structure into a three dimensional building panel system plan for the structure so that the structure can be constructed using a system of building panels. There is a need for standard building panels in the building panel system to have standard dimensions. There is a need for customized building panels in the building panel system to have customized dimensions. There is a need for the three dimensional building panel system plan to include the structural elements of each building panel in the panel system plan. There is a need to allow modification of the structural elements of a building panel in the panel system plan. There is a need for providing the panel system plan to a process for manufacturing each building panel in the panel system plan. There is a need to manufacture each of the building panels in the panel system with the structural elements specified in the panel system plan.

### SUMMARY OF THE INVENTION

According to an embodiment of the present invention, a method and system for converting a traditional two dimensional architectural plan for a structure into a three dimensional building panel system plan for the structure is provided. An traditional architectural plan along with any structural drawings for a structure is required as input. In an embodiment of the present invention, the traditional architectural plan is an electronic file. In an embodiment of the present invention, the traditional architectural plan is a paper document. In an embodiment of the present invention, the architectural plan is displayed on an output device such as a monitor. Selected walls of the structure depicted in the architectural plan, such as external walls, are replaced with representations of building panels. Some of the building panel representations (standard building panels) have substantially the same dimensions (i.e., height, width and length), but may be configured with different structural elements including, but not limited to, peripheral frame, window openings, door openings, and electrical components. Some of the building panel representations have dimensions that are customized (customized building panels) and different from the dimensions of standard building panel representations. Customized building panel representations can also include structural elements, including, but not limited to, window openings, door openings, and electrical components.

Once the selected walls have been replaced with the representations of the building panels, the representations of the building panels are translated into three dimensional representations, which include any structural elements associated with each of the building panels represented. Any structural element of a three dimensional representation of a building panel can be modified in ways which include, but are not limited to, the removal, relocation, and addition of already included structural elements as well as the addition of structured elements not included. The three dimensional representations are stored in a file as a three dimensional building panel system plan for the structural element.

According to an embodiment of the present invention, a process for manufacturing each building panel represented in the three dimensional building panel system plan is provided.

According to an embodiment of the present invention, the building panels in the three dimensional building panel system are manufactured with the structural elements specified in the three dimensional building panel system plan.

### BRIEF DESCRIPTION OF THE DRAWINGS

The above described features and advantages of the present invention will be more fully appreciated with reference to the detailed description and appended figures in which:

FIG. 1 depicts an exemplary block diagram of a system in which the present invention may be implemented.

FIG. 2 depicts an exemplary flow chart of a method for converting a traditional two dimensional architectural plan for a structure into a three dimensional building panel system plan for the structure.

FIG. 3 depicts an exemplary diagram of a standard building panel according to an embodiment of the present invention.

FIG. 4 an exemplary flow chart of a method of fabricating the building panel of FIGS. 3A-3B.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to an embodiment of the present invention, a method and system for converting a traditional two dimensional architectural plan for a structure into a three dimensional building panel system plan for the structure is provided. An traditional architectural plan along with any structural drawings for a structure is required as input. In an embodiment of the present invention, the architectural plan is displayed on an output device such as a monitor. Selected walls of the structure depicted in the architectural plan, such as external walls, are replaced with representations of building panels. Some of the building panel representations (standard building panels) have substantially the same dimensions (i.e., height, width and length), but may be configured with different structural elements including, but not limited to, peripheral frame, window openings, door openings, and electrical components. Some of the building panel representations have dimensions that are customized (customized building panels) and different from the dimensions of standard building panel representations. Customized building panel representations can also include structural elements, including, but not limited to, window openings, door openings, and electrical components.

Once the selected walls have been replaced with the representations of the building panels, the representations of the building panels are translated into three dimensional representations, which include any structural elements associated with each of the building panels represented. Any structural element of a three dimensional representation of a building panel can be modified in ways which include, but are not limited to, the removal, relocation, and addition of already included structural elements as well as the addition of structured not included elements. The three dimensional representations are stored in a file as a three dimensional building panel system plan for the structural element.

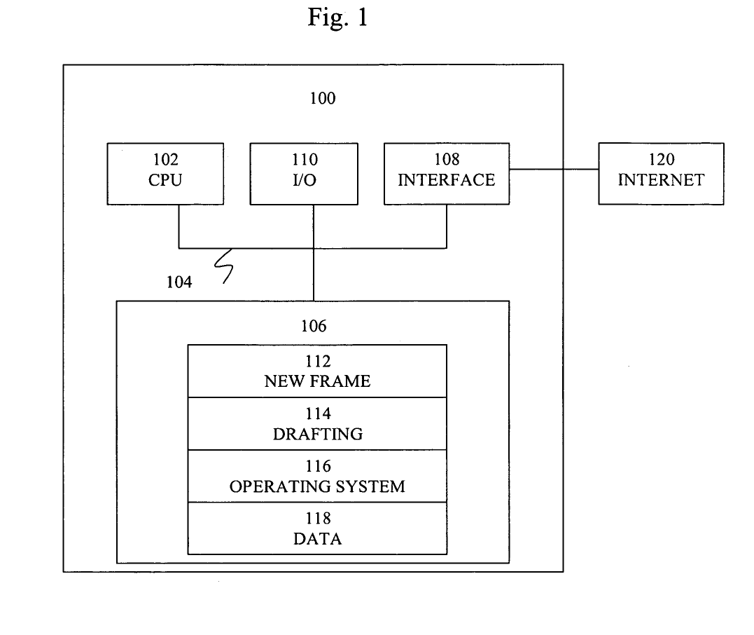

FIG. 1 is an exemplary block diagram of system 100 in which the present invention may be implemented. System 100 includes functionality to convert a traditional two dimensional architectural plan for a structure into a three dimensional building panel system plan. In the FIG. 1 embodiment, System 100 is a general purpose computer, such as a workstation, personal computer, server or the like, but may be any computer that executes program instructions in accordance with the present invention. System 100 includes a processor (CPU) 102 connected by a bus 104 to memory 106, network interface 108 and I/O circuitry 110.

In the FIG. 1 embodiment, CPU 102 is a microprocessor, such as an INTEL PENTIUM® processor, but may be any processor that executes program instructions in order to carry out the functions of the present invention. As shown, CPU 102 and the various other components of the system 100 communicate through a system bus 104 or similar architecture. Network interface 208 provides an interface between system 100 and a network, such as Internet 108. The network may be a local area network (LAN), a wide area network (WAN), or combinations thereof. I/O circuitry provides an interface for the input of data to, and output of data from, system 100. I/O circuitry includes input devices, such as trackball, mice, touchpads and keyboards, and output devices, such as printers and monitors.

In the FIG. 1 embodiment, memory 106 stores Software routines for execution by CPU 102. Memory 106 also stores data that is manipulated under the direction of CPU 102. Memory includes memory devices, such as read only memory (ROM), random access memory (RAM) hard disks, CDROMs, floppy disks, optical storage devices, magnetic storage devices, etc.

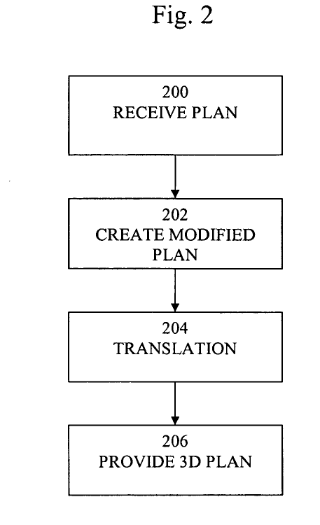

Memory 106 includes Software routines, such as processing software 112, drafting software 214, and operating system 216, as well as data, such as a library of building panels 218. In the FIG. 2 embodiment, the drafting and new frame software includes program instructions, which implement object-oriented technology, such as Java and C++. The program instructions provide the functionality implemented by the drafting and new frame software. The program instructions may be recorded on a computer readable medium and loaded into memory 206.

Data 218 includes standard and custom building panel representation information relevant to the standard and custom building panel representations as well as any other data necessary to perform computer aided drafting, design, and translation. Data serves as inputs to software, such as drafting software. Drafting software 214 executes routines to draft and design all types of structures from small residential types, such as homes, to large commercial and industrial structures, such as hospitals and factories. Processing software 212 executes routines to translate two dimensional representations of building panels into three dimensional representations, which include the depictions of any structural elements associated with each of the building panels represented. Operating system manages computer resources and provides an interface to access and manipulate those resources.

An exemplary flow chart for converting a traditional architectural plan for a structure into a three dimensional building panel system plan for the structure is shown in FIG. 2. The method begins in step 200. In step 200, a traditional two dimensional architectural design/plan is used as input. In an embodiment of the present invention, the architectural design is provided as output to a display device. In step 202, a two dimensional modified building panel design is created. In an embodiment of the present invention, the portion of the traditional architectural design to be converted is selected, such as the perimeter walls of the structure. The sections of the walls that include a door or window are identified. If a section of the wall that includes a door or window fits within the dimensions of a standard building panel, then that section of the wall is replaced with a representation of a standard building panel having a window or door element corresponding to the door or window for that section of the wall. Otherwise, the section of the wall is replaced with one or more representations of customized building panels having a window or door component corresponding to the window or door element to fit within the dimensions for that section. After the sections of the walls that include a door or window are replaced with the appropriate representations of building panels, the remaining sections of the wall the fit within the dimensions of a standard building panel are replaced with representations of standard building panels. Any remaining sections of the wall that do not fit within the standard building panel dimensions are replaced with one or more representations of customized building panels to fit the dimensions of those remaining walls.

In step 204, each representation of a building panel created for the two dimensional modified building panel design is translated into a three dimensional representation of the building panel, which includes the actual configuration of the building panel. In an embodiment of the present invention, the configuration will include the dimensions of the represented building panel along with any structural elements including, but not limited to, windows, doors, and electrical components. In an embodiment of the present invention, a three dimensional representation of a building panels can be modified. The modifications that can be performed on a three dimensional representation of a building panel includes, but is not limited to, the removal, relocation, and addition of already provided structural elements as well as the addition of structural elements.

In step 206, the three dimensional representations of the building panels are stored as a three dimensional building panel system plan for the structure. In an embodiment of the present invention, the three dimensional building panel system plan is stored as a file. In an embodiment of the present invention, the file can be provided to a manufacturer for the manufacture of each of the building panels represented in the file. In an embodiment of the present invention, the file is transmitted to the manufacture and used as input in the manufacturing process.

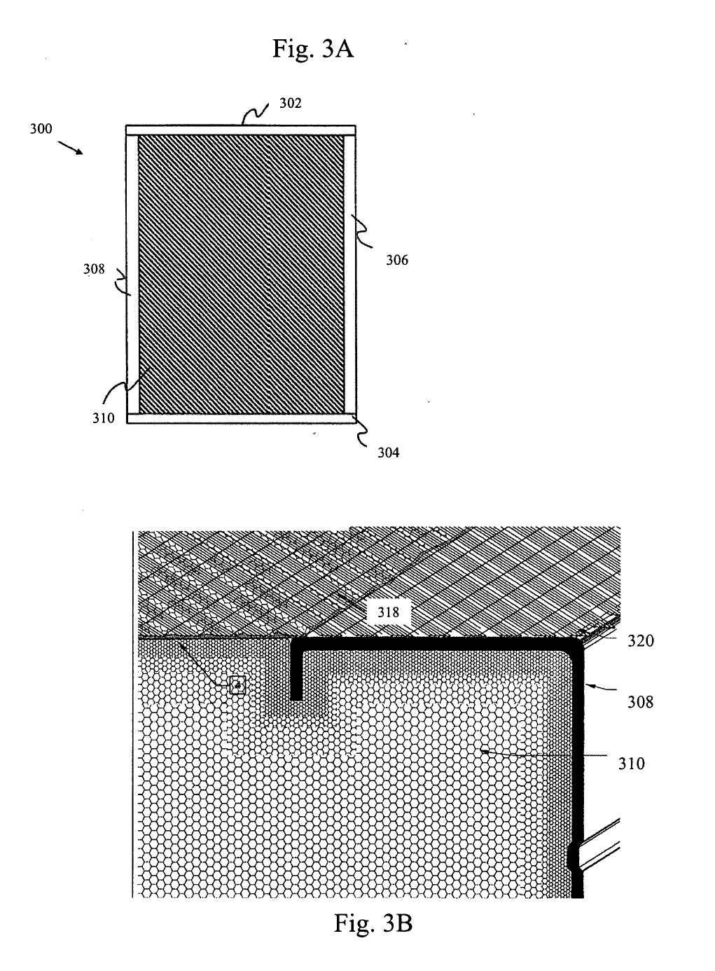

An exemplary diagram of a standard building panel according to an embodiment of the present invention are shown in FIG. 3A. In the embodiment of FIG. 3A, building panel 300 includes a top horizontal stud member 302, a bottom horizontal stud member 304, a right vertical stud member 306, a left vertical stud member 308, and a foam member 310. The building panel of FIG. 3A includes an exterior panel side 312, an interior panel side 314. In the FIG. 3A embodiment of the present invention, the top horizontal stud member 302, bottom horizontal stud member 304, right vertical stud member 306, and left vertical stud member 308 can be constructed from one of metal, aluminum, wood and plastic. In an embodiment of the present invention, a stud member, such as top horizontal stud member 302, bottom horizontal stud member 304, right vertical stud member 306, and/or left vertical stud member 308, can be configured as a conventional stud, a c-shaped stud, or the like. In an embodiment of the present invention, the foam member 310 forms around the c-shaped stud members to provide increase structural integrity

In an embodiment of the present invention, a surface of foam member 310 can be provided with a fiber to provide a fiber reinforced layer as shown in FIG. 3B. The fiber can be made from any material that strengthens the impact level of the panel member 300. The material can be, but is not limited to, Fiberglass, Aramid, Carbon and Natural fibers. In an embodiment of the present invention, the weight per square yard of the fiber can range from 12 oz. to 300 oz. In an embodiment of the present invention, the weight per square yard of the fibber can range from 12 oz. to 100 oz. In an embodiment of the present invention, the weight per square yard of the fiber can range from 75 oz. to 200 oz. In an embodiment of the present invention, the weight per square yard of the fibber can range from 125 oz. to 300 oz. The orientation of the fibers with respect to the longitudinal axis of the panel surface can be 0, +/−5, +/−10, +/−15, +/−30, +/−45, +/−60 and +/−90 degrees or any angle in between. The fiber layers can be either stitch bonded or woven together to form multiple ply layers which are utilized in the production of the panels.

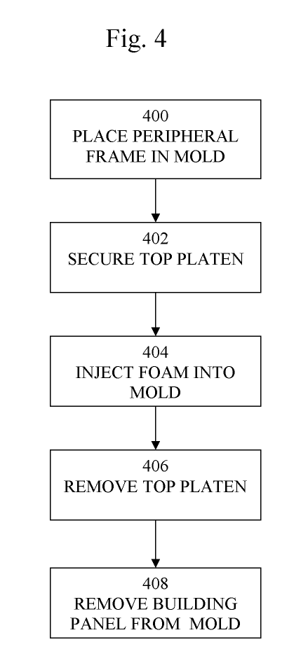

An exemplary flow chart of a method of fabricating the building panel of FIGS. 3A-3B is shown in FIG. 4. The method begins in step 400. In step 400, a peripheral frame of stud members is placed in a mold press. In an embodiment of the present invention, the peripheral frame is fabricated with electrical components including, but not limited to conduits for wiring, outlets and switch boxes. In an embodiment of the present invention, the peripheral frame is configured with an opening for a window or door. In an embodiment of the present invention, the peripheral frame is configured according to the configuration specified for a building panel in a three dimensional building system plan for a structure. In an embodiment of the present invention, the three dimensional plan is provided as a file to an automated system for fabricating building panels. In an embodiment of the present invention, the mold press includes an enclosure having a top platen that can be opened and closed, sidewalls and a bottom platen. In an embodiment of the present invention, a mesh is coupled to the peripheral frame. In an embodiment of the present invention, a mesh is suspended within the peripheral frame. In an embodiment of the present invention, dry fiber is laid on the bottom platen and/or provided on the top platen of the mold press and expanded to make the fiber taut.

In step 402, the top platen of the mold press is closed and secured to the sidewalls. In an embodiment of the present invention, the top platen is secured to the sidewalls with sufficient strength to sustain pressures achieved by the mold press. In an embodiment of the present invention, a release agent is applied to the top platen and/or the bottom platen to facilitate the removal of the building panel from the mold press. In one embodiment, the studs and/or mesh can be surface treated for improved bonding. Surface treatment can be effected by any of the several techniques known in the art, such as corona discharge, plasma treatment, ozone treatment, sand blasting, brush tumbling, and the like. Preferably, surface treatment is effected by grinding with an abrasive wheel. As will be appreciated by those of ordinary skill in the art, the effect of the surface treatment can vary based on the type of material used to fabricate the stud and/or mesh. For example, a metal stud can be subjected to sand blasting in order to increase the adhesion between the metal stud and the foam material.

In an alternate embodiment, a metal stud can be pretreated with a plasma thermal spray coating thus taking advantage of the ability of plasma technology to excite gas atoms and molecules into transient and nonequilibrium conditions. An enclosed vacuum chamber can be used to excite the gas molecules by subjecting the gas mixture to an electrified field of radio frequency (rf) energy. In the alternative, the plasma technology can be performed under atmospheric pressure and ambient temperature, without the use of vacuum equipment. The oxygen functionalities created on the surfaces are chemically reactive and permanent and allow the foam material to form a covalent bond to the modified surface.

In step 404, a foam system (“foam”) is injected and distributed consistently into the mold press. In an embodiment of the present invention, the foam is injected within, and bonded to, the peripheral frame. In an embodiment of the present invention, the foam is injected within, over, and bonded to, the frame. In an embodiment of the present invention, the foam has a thickness substantially equivalent to the thickness of the stud members of the peripheral frame. In an embodiment of the present invention, the foam has a thickness to substantially cover and encase the stud members of the peripheral frame. In an embodiment of the present invention, the mold press can be heated

In the FIG. 4 embodiment of the present invention, the press can be maintained above-ambient pressure, where the pressure is directly related to the density of the foam. In an embodiment of the present invention, the density of the foam can be based on the specific application that the building panel is going to be used. Any suitable temperature and pressure can be provided that allows the reaction to proceed. In an embodiment of the present invention, the temperature of the mold press can controlled by using techniques such as water-jacketing or heat strips. For example, the temperature of the mold press may range from about 32° F. to about 180° F. In one embodiment, the reaction temperature is about 75° F. to about 170° F. In another embodiment, the reaction occurs at a temperature of about 75° F. to about 150° F. In yet another embodiment, the reaction occurs at a temperature of about 80° F. to about 85° F. In yet another embodiment, the reaction occurs at a temperature of about 85° F. to about 120° F. The pressure may range from about 1 psi to about 15 psi. In one embodiment of the present invention, the pressure is about 3 psi to about 10 psi. In another embodiment of the present invention, the reaction occurs under a pressure of about 5 psi to about 7 psi.

The foam can be any suitable foam system that is capable of being injected and distributed consistently within the peripheral frame. For example, the foam system may be a thermoset material or a thermoplastic material. The foam system may include, but is not limited to, polystyrene, polyurethane, polyurea, polyisocyanurate, and the like. In one embodiment, the foam system is a molded expanded polystyrene foam. In another embodiment, the material is an extruded expanded polystyrene foam. To achieve a uniform density throughout the building panel an amount of foam is required per cubic feet. In an embodiment of the present invention, 2.2-2.3 cubic/ft of foam is required. In an embodiment, 2.3-2.8 cubic/ft of foam is required.

Foaming of the material of the invention may occur through the addition of at least one physical or chemical blowing or foaming agent. Suitable blowing or foaming agents include, but are not limited to, organic blowing agents, such as azobisformamide; azobisisobutyronitrile; diazoaminobenzene; N,N-dimethyl-N,N-dinitrosoterephthalamide; N,N-dinitrosopentamethylene-tetramine; benzenesulfonyl-hydrazide; benzene-1,3-disulfonyl hydrazide; diphenylsulfon-3-3, disulfonyl hydrazide; 4,4′-oxybis benzene sulfonyl hydrazide; p-toluene sulfonyl semicarbizide; barium azodicarboxylate; butylamine nitrile; nitroureas; trihydrazino triazine; phenyl-methyl-uranthan; p-sulfonhydrazide; peroxides; and inorganic blowing agents such as ammonium bicarbonate and sodium bicarbonate.

In another embodiment, the material is foamed forcing a pressurized gas, such as nitrogen or carbon dioxide, into the polymerizing mixture. In another embodiment, the material is foamed by blending microspheres with the composition either during or before the molding process. Polymeric, ceramic, metal, and glass microspheres are useful in the invention, and may be solid or hollow and filled or unfilled.

The foamed material may be closed-cell or open-cell, however, as known to those of ordinary skill in the art, a closed-cell foam material forms a hydrophobic top skin. As such, if the material of the invention is initially an open-cell foam, a subsequent sealant is preferred to add hydrophobicity to the cured material.

In step 406, the top platen of the mold press is removed once the foam has cured. In an embodiment of the present invention, curing of the mold takes 15-18 minutes. In an embodiment of the present invention, curing of the mold takes 12-15 minutes.

In step 408, the building panel is removed from the mold press. In an embodiment of the invention, the building panel is provided with a panel identifier. In an embodiment of the present invention, the panel identifier specifies a particular structure that the building panel is constructed for as well as the position of the panel with respect to other panels used for constructing the particular structure. In an embodiment of the invention, the panel identifier corresponds to a panel type amongst a plurality of standard building panel types that can be used to construct any number of different types of structures.

While specific embodiments of the present invention have been illustrated and described, it will be understood by those having ordinary skill in the art that changes can be made to those embodiments without departing from the spirit and scope of the invention.

What we claim is:

1. A computer implemented method of converting a traditional dimensional architectural plan for a structure into a three dimensional building panel system plan for the structure comprising:
receiving the traditional two dimensional architectural design/plan as input;
selecting a portion of the traditional architectural design/plan to be converted to panels;
identifying selected portion of the traditional architectural design/plan that includes a door or window;
determining whether the selected portion of the traditional architectural design/plan that includes a window or door that fits within the dimensions of a standard building panel;
if so, replacing the selected portion with a representation of a standard building panel having a window or door element corresponding to the door or window for that selected portion;
otherwise, replacing the selected portion with one or more representations of customized building panels having a window or door component corresponding to the window or door element to fit within the dimensions for that selected portion;
replacing remaining portions of the selected portions of the traditional architectural plan that do not include a window or door with and that fit within the dimensions of a standard building panel with appropriate representations of standard building panels; and
replacing remaining portions of the selected portions of the traditional architectural plan that do not include a window or door with and that do not fit within the dimensions of a standard building panel with one or more representations of customized building panels to fit the dimensions of those remaining walls.

2. The method according to claim 1, further comprising providing the architectural design as output to a display device.

3. The method according to claim 1, further comprising translating each representation of a building panel into a three dimensional representation of a building panel.

4. The method according to claim 3, wherein the three dimensional representation of each building panel includes the actual configuration of the building panel

5. The method according to claim 4, wherein the configuration includes structural elements including windows, doors, and electrical components.

6. The method according to claim 3, further comprising modifying the three dimensional representation of a building panel.

7. The method according to claim 3, further comprising storing the three dimensional representation of the building panels as a file.

8. The method according to claim 7, further comprising providing the file to a system for manufacturing building panels represented in the three dimensional representations stored in the file.

9. The method according to claim 1, further comprising converting the traditional two dimensional architectural design/plan to an electronic version of the two dimensional architectural design/plan.
